(19) United States
(12) Patent Application Publication
(10) Pub. No.: US 2009/0206182 A1
(43) Pub. Date: Aug. 20, 2009

(54) Rotary Atomizer with an Improved Valve

(75) Inventors: Michael C. Rodgers, Montpelier, OH (US); Gary W. Holloman, Martinsville, IN (US); George E. Nowling, Plainfield, IN (US); James J. McCall, Fishers, IN (US)

Correspondence Address: ABB INC.;LEGAL DEPARTMENT-4U6, 29801 EUCLID AVENUE, WICKLIFFE, OH, 44092, US

(73) Assignee: ABB Inc., Norwalk, CT (US)

(21) Appl. No.: 12/358,487

(22) Filed: Jan. 23, 2009

Related U.S. Application Data
(60) Provisional application No. 61/023,592, filed on Jan. 25, 2008.

(51) Int. Cl. B05B 1/30

(52) U.S. Cl. 239/583

(57) ABSTRACT

A valve assembly for controlling a flow of a coating to a spray head is provided. The valve assembly has a movable needle for closing an opening in a valve seat. The needle has a non-stick outer coating and extends through a needle seal having first and second ends. The first end of the needle seal is disposed inside a seal holder and abuts an interior surface of the seal holder. A spring applies a force to the second end of the needle seal, thereby pressing the first end of the needle seal against the interior surface of the seal holder.

### CROSS-REFERENCE TO RELATED APPLICATION

This application claims the benefit of U.S. provisional patent application No. 61/023,592 filed on Jan. 25, 2008, which is hereby incorporated by reference in its entirety.

### BACKGROUND OF THE INVENTION

This invention relates to rotary atomizers and more particularly to valves for rotary atomizers.

Rotary atomizers are commonly utilized in paint systems, particularly robotic paint systems used to paint automotive bodies. In such a robotic paint system, a rotary atomizer is connected to a wrist joint on an arm of an industrial robot. A conventional rotary atomizer includes an air motor that is operable to rotate an atomizer bell. Paint is fed to the atomizer bell through one or more needle-type valves. Examples of rotary atomizers with needle-type valves are shown in U.S. Patent Publication No. 20060104792 to Giuliano; U.S. Pat. No. 7,275,702 to Nolte et al.; U.S. Pat. No. 6,935,577 to Strong; and U.S. Pat. No. 6,164,561 to Yoshida et al, all of which are hereby incorporated by reference.

In a conventional needle-type valve, paint often adheres to the needle of the valve, especially if the paint is a multi-component paint having a resin and a catalyst that must be mixed for the paint to cure and dry. After a period of time, the paint builds up to a point where the needle fails to properly close the valve seat. At this point, the rotary atomizer fails to operate properly and must be disassembled, cleaned, repaired and reassembled, which is costly.

Based on the foregoing, it would be desirable to have a rotary atomizer with a valve that is less susceptible to fouling. The present invention is directed to such a rotary atomizer and a valve therefor.

### SUMMARY OF THE INVENTION

In accordance with the present invention, a valve assembly is provided for controlling a flow of a coating to a spray head. The valve assembly includes a valve seat, a piston and a needle. The valve seat has an opening through which the coating is supplied to the spray head, and the piston is movable between first and second positions. The needle has an end adapted for closing the opening in the valve seat. The needle is secured to the piston and is movable with the piston such that when the piston is in the first position, the end of the needle closes the opening in the valve seat, and when the piston is in the second position, the end of the needle does not close the opening in the valve seat. A seal holder and a needle seal are also provided. The seal holder has an interior surface defining a passage through which the needle extends. The needle also extends through the needle seal, which has first and second ends. The first end of the needle seal is disposed inside the passage of the seal holder and abuts the interior surface of the seal holder. A spring applies a force to the second end of the needle seal, thereby pressing the first end of the needle seal against the interior surface of the seal holder.

Also provided in accordance with the present invention is a rotary atomizer having a bell cup and an air motor connected to rotate the bell cup. A valve assembly is provided for controlling a flow of coating to the bell cup. The valve assembly has the construction described above.

### BRIEF DESCRIPTION OF THE DRAWINGS

The features, aspects, and advantages of the present invention will become better understood with regard to the following description, appended claims, and accompanying drawings where:

FIG. 1 shows a side view of a rotary atomizer;

FIG. 2 shows an exploded view of the rotary atomizer;

FIG. 3 shows a partially exploded view of a valve unit of the rotary atomizer;

FIG. 4 shows a partial sectional view of a valve body of the valve unit defining a cavity; and

FIG. 5 shows a sectional view of the valve body with a valve disposed in the cavity.

### DETAILED DESCRIPTION OF ILLUSTRATIVE EMBODIMENTS

It should be noted that in the detailed description that follows, identical components have the same reference numerals, regardless of whether they are shown in different embodiments of the present invention. It should also be noted that in order to clearly and concisely disclose the present invention, the drawings may not necessarily be to scale and certain features of the invention may be shown in somewhat schematic form.

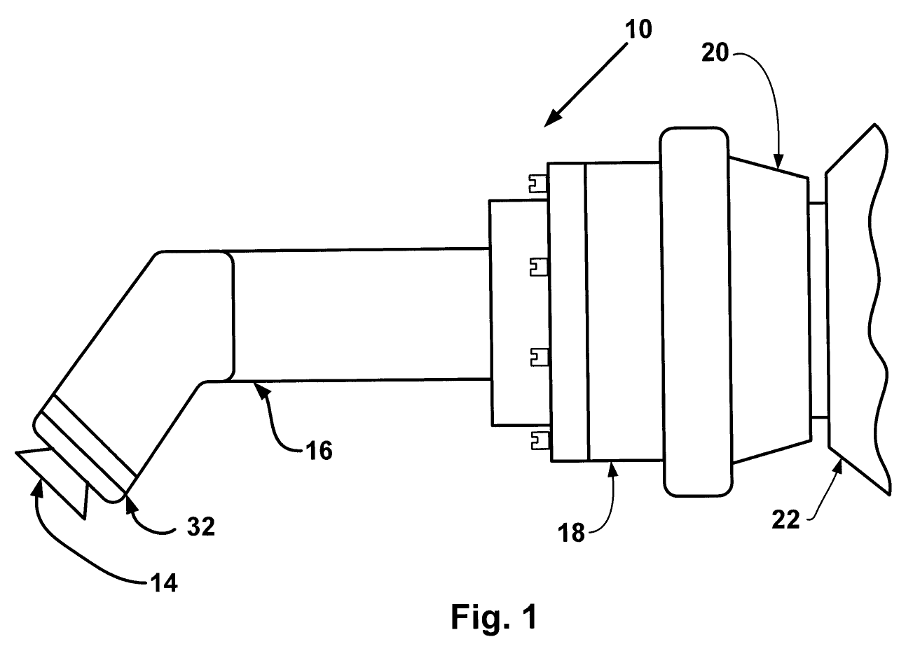

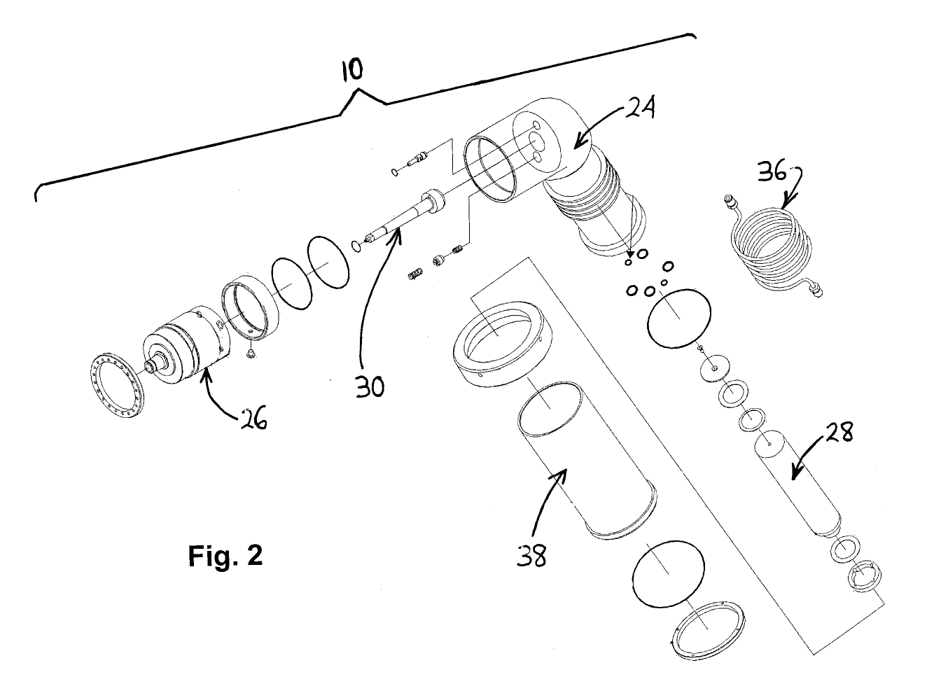

Referring now to FIGS. 1 and 2, there is shown a spray device 10 containing a valve 12 constructed in accordance with the present invention. The spray device 10 is a rotary atomizer adapted for spraying coatings and, in particular, paints. The spray device 10 generally includes a bell cup 14, a body 16, a valve unit 18 and a holder 20, which connects the spray device 10 to a wrist 22 of a robot.

The body 16 includes a main housing 24 that encloses an air motor 26, a high voltage generator 28 and a feed tube assembly 30. A sleeve or cover 38 is disposed over the main housing 24. The air motor 26 is connected to the bell cup 14 and is operable, when provided with pressurized air, to rotate the bell cup 14 at a high speed. When the bell cup 14 is rotating and is provided with paint by the feed tube assembly 30, the bell cup 14 sprays the paint outwardly in finely atomized particles. An air shaping ring 32 is mounted to the body 16, proximate to the bell cup 14, and includes a plurality of holes through which high pressure air is ejected toward the bell cup 14. The placement of the holes and the pressure of the ejected air are selected to produce air streams that shape the paint particles from the bell cup 14 into a predetermined spray pattern. In this manner, the bell cup 14 and the air shaping ring 32 work together to function as a spray head.

The bell cup 14 and the air shaping ring 32 are charged with high voltage DC power from the high voltage generator 28 so that the atomized paint particles become electrically charged and are drawn along an electrostatic field formed between the spray device 10 and a grounded object to be painted, such as an automobile body. The high voltage generator 28 receives low AC voltage power from a remote power supply and converts it to high DC voltage power, which is then transmitted to the bell cup 14 and the air shaping ring 32. The high voltage generator 28 may be a Cockcroft-Walton generator, which comprises a cascade of series-connected diode/capacitor voltage doubling stages.

The feed tube assembly 30 extends through the air motor 26 and has an outer end connected to the bell cup 14. An inner end of the feed tube assembly 30 is connected by a tubing system 36 to the valve unit 18. The tubing system 36 is arranged in a helical configuration that extends around the main housing 24 and is positioned between the main housing 24 and the cover 38. The tubing system 36 may be secured to an inner surface of the cover 38.

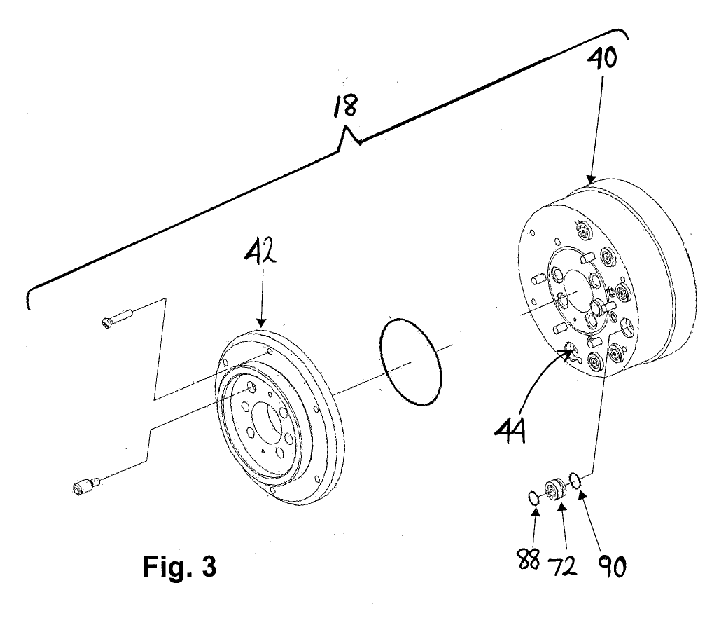

Referring now to FIG. 3, the valve unit 18 is operable to control the flow of one or more paints to the feed tube assembly 30 and, thus, the bell cup 14. The valve unit 18 comprises a valve body 40 and a flange 42, each of which is composed of a plastic, such as polyoxymethylene. The valve body 40 includes one or more cavities 44 holding one or more of the valves 12, respectively. In one embodiment of the present invention, the valve body 40 has a plurality of cavities 44 with valves arranged in a circular pattern.

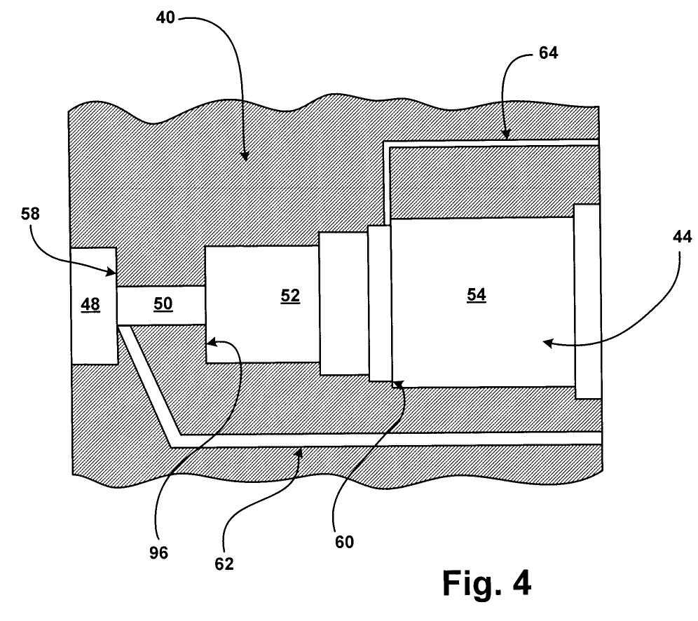

With reference now to FIG. 4, each cavity 44 generally includes a forward portion 48, a neck portion 50, a central portion 52 and a rearward portion 54. The forward portion 48 and the neck portion 50 are separated by a shoulder 58 and the central portion 52 and the rearward portion 54 are separated by a shoulder 60. A portion of an interior wall defining the rearward portion 54 is threaded. A paint passage 62 and an air passage 64 extend through the valve body 40. An exit end of the paint passage 62 is connected into the neck portion 50 at the juncture between the neck portion 50 and the forward portion 48, while an exit end of the air passage 64 is connected into the central portion 52 at the juncture between the central portion 52 and the rearward portion 54.

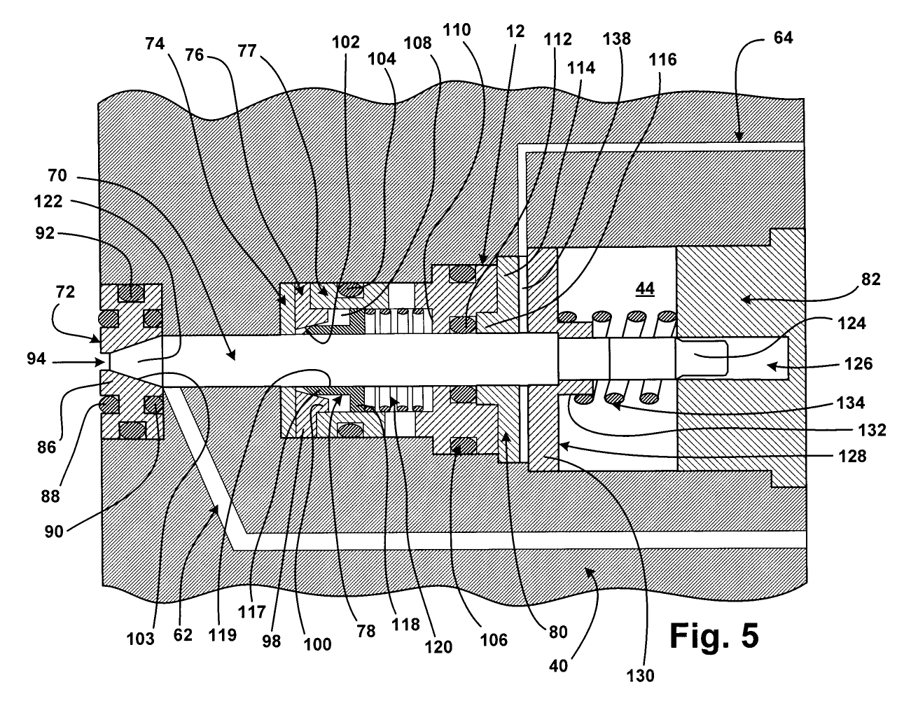

Referring now to FIG. 5, each valve 12 generally includes a needle 70, a valve seal 72, a seal ring 74, a seal holder 76, a retainer 77, a needle seal 78, a seal nut 80 and a cover plug 82. In the paragraphs to follow, only one valve 12 mounted in one cavity 44 is described, it being understood that other valves 12 have substantially the same construction and mounting.

The valve seal 72 has a body 86 composed of a polymer, such as polyvinylidene difluoride (PVDF). Annular grooves are formed in the body 86 to hold front and rear O-rings 88, 90 and a circumferential O-ring 92. An interior surface forms a passage 94 that extends through the body 86. The interior surface has a frustoconical (tapered) section that forms a valve seat 103. The valve seal 72 is snugly received in the forward portion 48 of the cavity 44, with the front and rear O-rings 88, 90 and the circumferential O-ring 92 providing seals between the valve seal 72 and the valve body 40.

The seal ring 74 is annular and is composed of a polymer that is chemically resistant and advantageously has a low coefficient of resistance. A suitable polymer may be polyetheretherketone (PEEK), or more advantageously polytetrafluoroethylene (PTFE). The seal ring 74 is snugly received in the central portion 52 of the cavity 44 and abuts an interior wall 96 of the valve body 40 that helps define the central portion 52.

The seal holder 76 has a cylindrical body 98 with an integrally joined cylindrical hub 100 extending axially outward therefrom. The seal holder 76 is disposed in the central portion 52 of the cavity 44, abutting the seal ring 74. An interior surface 102 of the seal holder 76 forms a passage that extends through the seal holder 76. The interior surface 102 and, thus the passage is sloping or tapered, or more specifically frustoconical. The seal holder 76 is composed of a polymer that is chemically resistant and advantageously has a low coefficient of resistance. A suitable polymer may be PTFE, or more advantageously PEEK.

The retainer 77 is generally cylindrical and may be composed of a metal such as stainless steel. Annular grooves are formed in an outside surface of the retainer 77 and hold front and rear O-rings 104, 106. Inside the retainer 77, a main cavity 108 is separated from a posterior cavity by an annular wall 110. An O-ring 112 is disposed on the wall 110 in the posterior cavity. The retainer 77 is disposed in the central portion 52 of the cavity 44 and abuts the body 98 of the seal holder 76 around the hub 100, which extends into the main cavity 108 of the retainer 77. The front and rear O-rings 104, 106 provide liquid seals between the retainer 77 and the valve body 40.

The seal nut 80 may be composed of a metal, such as stainless steel, and includes a cylindrical body 114 with an integrally joined cylindrical hub 116 extending axially outward therefrom. A cylindrical passage extends through the seal nut 80. The seal nut 80 is disposed in the central portion 52 of the cavity 44, with the hub 116 extending into the posterior cavity of the retainer 77 and abutting the O-ring 112, which provides a seal between the seal nut 80 and the retainer 77.

The needle seal 78 includes a cylindrical body 117 having a posterior end integrally joined to an annular base 118. A free forward end of the body 117 has a shape that is sloped, tapered, or more specifically frustoconical. An axial passage 119 extends through the body 117 and the base 118. The needle seal 78 is composed of a polymer that is chemically resistant, has a low coefficient of resistance and is relatively soft, i.e., is relatively resilient. One such polymer that has been found suitable for use in forming the needle seal 78 is polytetrafluoroethylene (PTFE). The needle seal 78 is disposed inside the main cavity 108 of the retainer 77, with the forward end of the body 117 disposed in the passage of the seal holder 76 and abutting the interior surface 102.

A helical spring 120 is also positioned inside the main cavity 108 of the retainer 77 and is disposed around the needle seal 78. The spring 120 is composed of a metal, such as stainless steel, and has a first end disposed against the base 118 of the needle seal 78 and a second end disposed against the wall 110. In this manner, the spring 120 extends between the needle seal 78 and the wall 110. The spring 120 applies a force to the base 118 that presses the tapered first end of the body 117 into sealing engagement with the interior surface 102 of the seal holder 76 inside the passage. Since the needle seal 78 is composed of a relatively soft polymer, such as PTFE, the force of the spring 120 causes the first end of the body 117 to deform so as to better conform with the contour of the interior surface 102 and, in so doing, to press against the needle 70, as described more fully below. The force applied by the spring 120 is from about 6 pound-force to about 10 pound-force, more particularly about 8 pound-force.

The cover plug 82 includes a body with an outer surface having a thread formed therein. The thread in the cover plug 82 is adapted to threadably mate with the thread formed in the interior wall defining the rearward portion 54 of the cavity 44. In this manner, the cover plug 82 can be threadably secured in the rearward portion 54 of the cavity 44.

The needle 70 extends through the cavity 44 from the valve seal 72 to the cover plug 82. In so doing, the needle 70 extends through the central opening in the seal ring 74, the passage in the seal holder 76, the passage 119 in the needle seal 78, the main cavity 108 and the posterior cavity of the retainer 77 and the passage in the seal nut 80. The needle 70 has a frustoconical (tapered) forward portion 122 and a rearward portion 124 disposed in a bore 126 of the cover plug 82. The needle 70 includes a base structure composed of a metal, such as stainless steel. An outer coating or layer is formed over the base structure to improve the surface properties of the needle 70. More specifically, the outer layer increases the hardness of the needle 70, improves the surface finish by filling in all surface irregularities in the base structure created during machining and creates a non-stick surface that paint cannot adhere to. The outer layer may be applied to the base structure by a physical vapor deposition process, such as evaporative deposition, electron beam physical vapor deposition, sputter deposition, cathodic arc deposition and pulsed laser deposition. The outer layer may be titanium nitride (TiN), titanium aluminum nitride (TiAlN), aluminum titanium nitride (AlTiN), titanium carbon nitride (TiCN) and zirconium nitride (ZrN). Titanium aluminum nitride (TiAlN) has been found particularly advantageous.

A piston 128 is secured to the needle 70 and extends radially outward therefrom. The piston 128 includes a cylindrical body 130 with an integral cylindrical hub 132 extending axially outward therefrom. The piston 128 may be formed from a metal, such as aluminum or an aluminum alloy. The piston 128 is movable within the rearward portion 54 of the cavity 44 between a first position, wherein the piston 128 is disposed against the shoulder 60, and a second position, wherein the piston 128 is spaced from the shoulder 60. Movement of the piston 128 past the second position, in the direction of the cover plug 82 is prevented by the piston 128 abutting the cover plug 82 and/or the rearward portion 124 of the needle 70 abutting an interior end wall within the cover plug 82. A helical spring 134 is disposed around the hub 132 and the needle 70. The spring 134 is composed of a metal, such as stainless steel, and has a first end disposed against the body 130 of the piston 128 and a second end disposed against the cover plug 82. In this manner, the spring 134 extends between the piston 128 and the cover plug 82. The spring 134 applies a force to the piston 128 that biases the piston 128 toward the first position, against the shoulder 60.

When the piston 128 is in the first position, a gap 138 is formed between the piston 128 and the seal nut 80. The gap 138 is in air flow communication with the air passage 64 which extends through the valve body 40. The air passage 64 is connected through one or more control valves (not shown) to a source of high pressure air. When high pressure air is supplied to the air passage 64, the high pressure air enters the gap 138 and moves the piston 128 to the second position, against the bias of the spring 134.

The movement of the piston 128 between the first and second positions causes the needle 70 to open and close the valve 12. More specifically, when the piston 128 is in the first position, the needle 70 is positioned such that the forward portion 122 of the needle 70 is tightly disposed in the passage 94, against the valve seat 103 of the valve seal 72, thereby closing the passage 94, i.e., closing the valve 12. When the piston 128 is in the second position, the needle 70 is positioned such that the forward portion 122 of the needle 70 is disposed rearward of both the passage 94 and the exit end of the paint passage 62, thereby opening the passage 94 to the flow of paint from the paint passage 62, i.e., opening the valve 12.

As a result of the opening and closing of the valve 12, paint from the paint passage 62 may migrate upstream along the needle 70, toward the retainer 77. The biased needle seal 78 in conjunction with seal holder 76, however, prevents any such migrating paint from traveling any further upstream. As set forth above, the spring 120 applies a force to the base 118 of the needle seal 78, which causes the needle seal 78 to deform against the interior surface 102 of the seal holder 76. The deformation of the needle seal 78 collapses (narrows) the internal diameter of the passage 119 of the needle seal 78 against the needle 70, thereby forming a seal that is fluid tight and prevents paint from traveling any further rearward. This seal also acts as a wiper, effectively wiping away paint as the valve 12 is turned on and off. This wiping action prevents paint from being pulled past the needle seal 78 and drying, which would cause the valve 12 to lock up. The wiping action also keeps the paint inside the portion of the valve 12 that can be flushed with solvent when changing from one color to another, or when a general cleaning of the spray device 10 is performed.

In addition to having the above-described seal against paint migration, the valve 12 has the needle 70, which does not collect paint. The outer layer of titanium aluminum nitride (TiAlN) or other suitable non-stick composition prevents paint from sticking to the needle 70 and drying, which can cause the valve 12 to lock up.

All of the components of the valve 12, i.e., the needle 70, the valve seal 72, the seal ring 74, the seal holder 76, the retainer 77, the needle seal 78, the seal nut 80 and the cover plug 82 are removable from the cavity 44. This construction permits components of the valve 12 to be removed, cleaned (or replaced) and then reinstalled in the cavity 44. The construction also permits the valve 12 to be used to retrofit a rotary atomizer having a different valve.

It is to be understood that the description of the foregoing exemplary embodiment(s) is (are) intended to be only illustrative, rather than exhaustive, of the present invention. Those of ordinary skill will be able to make certain additions, deletions, and/or modifications to the embodiment(s) of the disclosed subject matter without departing from the spirit of the invention or its scope, as defined by the appended claims.

What is claimed is:

1. A valve assembly for controlling a flow of a coating to a spray head, the valve assembly comprising:
a valve seat having an opening through which the coating is supplied to the spray head;
a piston movable between first and second positions;
a needle having an end adapted for closing the opening in the valve seat, the needle being secured to the piston and being movable with the piston such that when the piston is in the first position, the end of the needle closes the opening in the valve seat, and when the piston is in the second position, the end of the needle does not close the opening in the valve seat;
a seal holder having an interior surface defining a passage through which the needle extends;
a needle seal through which the needle extends, the needle seal having first and second ends, the first end being disposed inside the passage of the seal holder and abutting the interior surface of the seal holder; and
a spring applying a force to the second end of the needle seal, thereby pressing the first end of the needle seal against the interior surface of the seal holder.

2. The valve assembly of claim 1, wherein the spring is a first spring, and wherein the valve assembly further comprises a second spring that biases the piston toward the first position.

3. The valve assembly of claim 1, wherein the seal holder and the needle seal are polymeric.

4. The valve assembly of claim 3, wherein the seal holder is comprised of polyetheretherketone.

5. The valve assembly of claim 3, wherein the needle seal is comprised of polytetrafluoroethylene.

6. The valve assembly of claim 3, wherein the interior surface of the seal holder is sloped and the first end of the needle seal is sloped.

7. The valve assembly of claim 6, wherein the needle seal comprises a cylindrical body joined to an annular base, the body having an end that comprises the first end of the needle seal and the base having a surface that comprises the second end of the needle seal.

8. The valve assembly of claim 1, further comprising a valve body defining a valve cavity, and wherein the valve seat, the piston, the needle, the seal holder, the needle seal and the spring are disposed in the valve cavity.

9. The valve assembly of claim 8, further comprising a retainer that is disposed in the valve cavity and defines an interior retainer cavity, the needle seal and the spring being disposed in the retainer cavity.

10. The valve assembly of claim 9, wherein the seal holder comprises a cylindrical body with an integrally joined hub extending axially outward therefrom, the hub extending into the retainer cavity and a surface of the body disposed around the hub abutting an end of the retainer.

11. The valve assembly of claim 10, wherein the retainer is composed of metal and has peripheral grooves with O-rings disposed therein.

12. The valve assembly of claim 8, wherein the valve body is polymeric.

13. The valve assembly of claim 12, wherein the valve seat, the piston, the needle, the seal holder, the needle seal and the spring are removable from the cavity.

14. The valve assembly of claim 1, wherein the needle comprises a base structure composed of metal and an outer layer disposed over the base structure, the outer layer being formed from a material selected from the group consisting of titanium nitride (TiN), titanium aluminum nitride (TiAlN), aluminum titanium nitride (AlTiN), titanium carbon nitride (TiCN) and zirconium nitride (ZrN).

15. The valve assembly of claim 14, wherein the outer layer is formed from titanium aluminum nitride (TiAlN).

16. A rotary atomizer for spraying a coating received from a supply of the coating, the rotary atomizer comprising:
(a.) a bell cup;
(b.) an air motor connected to the bell cup and operable to rotate the bell cup when provided with air; and
(c.) a valve assembly for controlling a flow of the coating to the bell cup, the valve assembly comprising:
a valve seat having an opening through which the coating is supplied to the bell cup;
a piston movable between first and second positions;
a needle having an end adapted for closing the opening in the valve seat, the needle being secured to the piston and being movable with the piston such that when the piston is in the first position, the end of the needle closes the opening in the valve seat, and when the piston is in the second position, the end of the needle does not close the opening in the valve seat;
a seal holder having an interior surface defining a passage through which the needle extends;
a needle seal through which the needle extends, the needle seal having first and second ends, the first end being disposed inside the passage of the seal holder and abutting the interior surface of the seal holder; and
a spring applying a force to the second end of the needle seal, thereby pressing the first end of the needle seal against the interior surface of the seal holder.

17. The rotary atomizer of claim 16, wherein the spring is a first spring, and wherein the valve assembly further comprises a second spring that biases the piston toward the first position.

18. The rotary atomizer of claim 16, wherein the needle seal is formed from polytetrafluoroethylene and comprises a cylindrical body joined to an annular base, the body having a sloped end that comprises the first end of the needle seal and the base having a planar surface that comprises the second end of the needle seal.

19. The rotary atomizer of claim 18, wherein the valve assembly further comprises a retainer that is disposed in the valve cavity and defines an interior retainer cavity, the needle seal and the spring being disposed in the retainer cavity;
wherein the seal holder comprises a cylindrical body with an integrally joined hub extending axially outward therefrom, the hub extending into the retainer cavity and a surface of the body disposed around the hub abutting an end of the retainer; and
wherein the interior surface of the seal holder is sloped.

20. The rotary atomizer of claim 16, wherein the needle comprises a base structure composed of metal and an outer layer disposed over the base structure, the outer layer being formed from a material selected from the group consisting of titanium nitride (TiN), titanium aluminum nitride (TiAlN), aluminum titanium nitride (AlTiN), titanium carbon nitride (TiCN) and zirconium nitride (ZrN).

21. The rotary atomizer of claim 20, wherein the base structure is comprised of aluminum and the outer layer is formed from titanium aluminum nitride (TiAlN).
